(19) United States
(12) Patent Application Publication
(10) Pub. No.: US 2015/0378086 A1
(43) Pub. Date: Dec. 31, 2015

(54) OPTICAL ASSEMBLY, MANUFACTURING METHOD FOR THE SAME AND DISPLAY DEVICE

(71) Applicants: BOE Technology Group Co., Ltd., Beijing (CN); Hefei BOE Display Light Co., Ltd., Anhui (CN)

(72) Inventors: Qinggang Feng, Beijing (CN); Yaling Kang, Beijing (CN)

(21) Appl. No.: 14/472,590

(22) Filed: Aug. 29, 2014

(30) Foreign Application Priority Data
Jun. 27, 2014 (CN) 201410301660.3

(51) Int. Cl. F21V 8/00; B32B 38/00; B32B 37/02; G02F 1/1335; B32B 37/18

(52) U.S. Cl. CPC G02B 6/0051; G02F 1/133504; G02B 6/0053; G02B 6/0055; B32B 37/18; B32B 37/02; B32B 38/00; B32B 2307/40; B32B 2551/00

(57) ABSTRACT

The present disclosure of the present invention provides an optical assembly, a manufacturing method thereof, and a display device. Specifically, the optical assembly for a backlight module includes a light guide plate; and a set of optical membranes located on a light exiting surface of the light guide plate. The light guide plate is adhesively fixed with the set of optical membranes by a first transparent adhesive layer.

### CROSS-REFERENCE TO RELATED APPLICATION

This application claims the benefit of Chinese Patent Application No. 201410301660.3 filed on Jun. 27, 2014 in the State Intellectual Property Office of China, the whole disclosure of which is incorporated herein by reference.

### BACKGROUND OF THE INVENTION

1. Field of the Invention

The present disclosure relates to a technical field of display, more particularly, to an optical assembly, a manufacturing method for the same, a backlight module and a display device comprising the same.

2. Description of the Related Art

A liquid crystal display is widely used in apparatuses such as monitors, personal computers, digital cameras, projectors and liquid crystal TVs, since it has advantages of, for example, light weight, thin thickness, low radiation and HD display. The liquid crystal display pertains to one type of non-self-emissive display, and thus it must display images with the aid of a backlight module. Therefore, the development of the backlight technique will have a significant effect on a performance of the liquid crystal display.

As shown in FIG. 1, it shows out a schematic sectional view of an optical assembly for a backlight module in the prior art. The optical assembly includes a reflecting sheet 1, a light guide plate 2, a diffusion sheet 3, a prism sheet 4 and a protective sheet 5 from bottom to top. The diffusion sheet 3, the prism sheet 4 and the protective sheet 5 (if any) are called as a set of optical membranes. When assembling the backlight module, each optical part of the optical assembly should be positioned and installed on a support plate of the backlight module. Since all the optical parts need to be positioned respectively, it tends to inaccurately position them. In addition, after assembling of the backlight module, there is also a gap between two adjacent parts of the optical parts, in particular, a bigger gap between the light guide plate 2 and the diffusion sheet 3. During the mechanical test thereof, it is easy to give rise to the issues such as scratching or entry of foreign matters. Moreover, in the assembling process of the optical assembly, due to several optical parts, it tends to cause a problem of poor assembly.

In view of the above, if several optical parts of the optical assembly need to be respectively positioned, then it would reduce the positioning accuracy, and cause the assembly difficulty of the backlight module. Finally, it would reduce the producing efficiency of the product.

### SUMMARY OF THE INVENTION

In order to eliminate the above or other technical problems in the prior art, the present disclosure provides an optical assembly, a manufacturing method thereof, a backlight module and a display device.

In accordance with one aspect of the present invention, it provides an optical assembly for a backlight module, comprising:

a light guide plate; and

a set of optical membranes located on a light exiting surface of the light guide plate;

wherein the light guide plate is adhesively fixed with the set of optical membranes by a first transparent adhesive layer.

In accordance with another aspect of the present invention, it provides a manufacturing method for an optical assembly, comprising the following steps:

forming a network node surface by making network nodes on a reflecting surface of the light guide plate;

coating a reflecting layer onto the network node surface and adhesively fixing a second protective sheet onto the reflecting layer by a transparent adhesive layer;

adhesively fixing a set of optical membranes onto a light exiting surface of the light guide plate by a first transparent adhesive layer; and

adhesively fixing respective optical membranes of the set of optical membranes by a second transparent adhesive layer.

In accordance with a further aspect of the present invention, it provides a backlight module, comprising:

the optical assembly as described above,

a backlight source located at a light incidence side of the light guide plate, and

a support plate for securing the optical assembly and the backlight source.

In accordance with a yet further aspect of the present invention, it provides a display device, comprising:

a backlight module as described above; and

a display panel located at a light exiting side of the backlight module.

### BRIEF DESCRIPTION OF THE DRAWINGS

The above and other features of the present invention will become more apparent by describing in detail exemplary embodiments thereof with reference to the accompanying drawings, in which:

FIG. 1 is a schematic sectional view of an optical assembly for a backlight module in the prior art;

FIG. 2 is a schematic sectional view of an optical assembly for a backlight module in accordance with a first embodiment of the present invention;

FIG. 3 is a schematic sectional view of an optical assembly for a backlight module in accordance with a second embodiment of the present invention; and

FIG. 4 is a schematic sectional view of an optical assembly for a backlight module in accordance with a third embodiment of the present invention.

Explanations of reference numbers:

1-reflecting sheet

2-light guide plate

3-diffusion sheet

4-prism sheet

5-protective sheet

6-reflecting layer

7-first protective sheet

8-second protective sheet

11-first transparent adhesive layer

12-second transparent adhesive layer

21-holographic light guide plate

111-light diffusion transparent adhesive layer

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In order to improve the convenience of assembly, at least a part of embodiments of the present invention provide an optical assembly, a manufacturing method thereof, a backlight module and a display device. In the technical solutions of the present invention, since a network node surface of a light guide plate is directly provided with a reflecting layer thereon, and/or the light guide plate and a set of optical membranes are adhesively fixed to each other together, thus the optical assembly is of an integral structure. When assembling the optical assembly into a backlight module, one time positioning of the integral optical assembly replaces respectively positioning of all the optical parts, thus improving the positioning accuracy of the optical assembly, the convenience of the assembly of the backlight module, and producing efficiency of the products. In order to enable objects, technical solutions and advantages of the present invention to become apparent, specific embodiments of the present invention are now discussed in detail.

Since improvements of the present invention mainly focus on structural arrangement and manufacturing methods of the optical assembly for the backlight module, the improvements will be explained in detail in the following. Further, known components in the art such as a backlight source, a support plate for the backlight module will be briefly explained. Since these components can be known from the prior art and are not improved on terms of structure and arrangement, they are not shown in the accompanying figures.

FIG. 2 is a schematic sectional view of an optical assembly for a backlight module in accordance with a first embodiment of the present invention. The optical assembly includes a light guide plate 2, and a set of optical membranes located on a light exiting surface (i.e., a side for exiting the light) of the light guide plate 2. The light guide plate 2 and the set of optical membranes are adhesively fixed by a first transparent adhesive layer 11. In addition, respective optical membranes of the set of optical membranes are adhesively fixed with each other by a second transparent adhesive layer 12.

In an example, the first transparent adhesive layer 11 has a light transmissivity higher than 90%, and is made of any one of organic silicon rubber, acrylic resin, unsaturated polyester resin, polyurethane resin and epoxy resin or any combination thereof. In addition, the second transparent adhesive layer 12 has a light transmissivity higher than 90%, and is made of any one of organic silicon rubber, acrylic resin, unsaturated polyester resin, polyurethane resin and epoxy resin or any combination thereof.

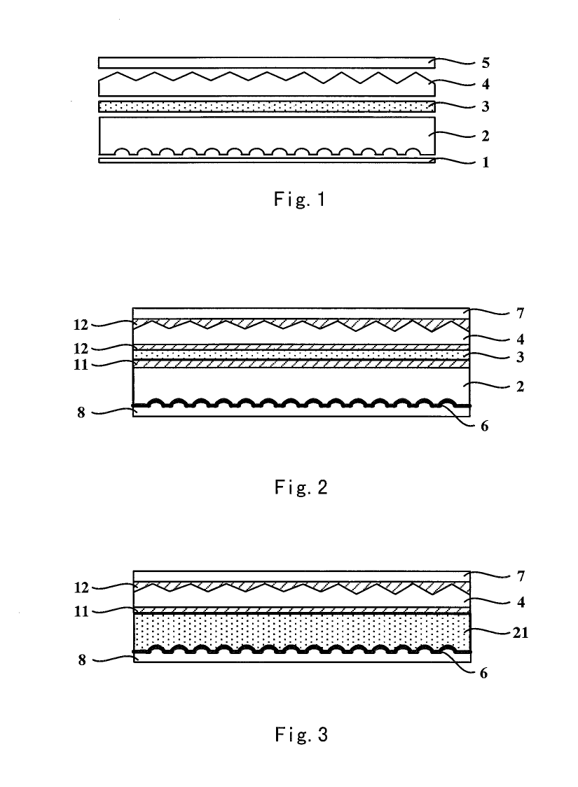

One side of the light guide plate 2 opposite to the light exiting surface is a network node surface provided with network nodes (herein, also called as a reflecting surface), and such network node surface is provided with a reflecting layer 6. Of course, in some cases, the reflecting layer 6 can be replaced by the reflecting sheet as shown in FIG. 1, which is fixed on the opposite side by a suitable means (such as an adhesive means).

Optionally, the optical assembly further includes a second protective sheet 8 located on one side of the reflecting layer 6 facing away from the light guide plate 2. The second protective sheet 8 is used to prevent scratching the reflecting layer 6. Of course, the second protective sheet 8 can also be adhesively fixed, for example, the second protective sheet 8 is adhesively fixed with the reflecting layer 6 by the first or second transparent adhesive layer 11 or 12 as described above.

Since the network node surface of the light guide plate 2 is directly provided with a reflecting layer 6 and/or the light guide plate 2 and the set of optical membranes are adhesively fixed to each other together, the optical assembly is integral. When assembling the optical assembly for the backlight module, the integral optical assembly is positioned within the backlight module (for example, a support plate thereof) at one time, so as to replace the respectively positioning each optical component into the backlight module in the prior art. In this way, it improves the positioning accuracy of the optical assembly, the assembly convenience of the backlight module and further the producing efficiency of the products. In addition, since there is no gap between any two adjacent optical components, during the mechanical test thereof, the problems such as scratching or entry of the foreign matters will be suppressed, thereby improving the yield of the backlight module. During assembling of the backlight module, since only one integral optical assembly is to be positioned, the poor assembly possibility is significantly reduced. In addition, because there are no gaps among the optical parts, it can decrease the optical loss, and improve the utilization of the light source in the backlight module.

As shown in FIG. 2, the set of optical membranes includes a diffusion sheet 3 and a prism sheet 4. Optionally, the set of optical membranes further includes a first protective sheet 7 for protecting the set of optical membranes. In the present embodiment, the optical membranes such as the diffusion sheet 3 and the prism sheet 4 in the set of the optical membranes can be modified as actually required, and not limiting to those described above.

In other embodiments of the present invention, in addition to being locating on the network node surface of the light guide plate 2, the reflecting layer 6 can be located on other sides of the light guide plate 2 other than the light incidence surface (i.e., a surface at the light incidence side) and the light exiting surface (i.e., a surface at the light exiting side). A part shown by a wave line in FIG. 2 is the network node surface, which is generally opposite to a position where the light exiting surface is located. The reflecting layer 6 can be made of materials having high reflectivity, for example, barium sulfate or polyester. The reflecting layer 6 can be made by for example a coating method, a soaking method or a depositing method. Taking the soaking method as one example, the light incidence and exiting surfaces of the light guide plate 2 are adhered and coated with a protective film, and then the light guide plate 2 is soaked within a solution of the material having high reflectivity. Finally, the soaked light guide plate 2 is taken out of the solution, dried and all the coated protective film are peeled from the soaked light guide plate 2, so as to obtain the light guide plate 2 having the reflecting layer 6.

In other embodiment of the present invention, the integral optical assembly can also be obtained by a 3D printing technique.

The optical assembly as shown in FIG. 2 can be obtained by the following steps:

peeling off a protective film on a reflecting surface of the light guide plate 2, and forming a network node surface by making network nodes on the reflecting surface of the light guide plate 2;

coating the reflecting layer 6 onto the network node surface, and disposing (for example, adhering) the second protective sheet 8 onto the reflecting layer 6 by the first or second transparent adhesive layer 11 or 12;

peeling off a protective film on the light exiting surface of the light guide plate 2 and providing (for example, uniformly transferring) the first transparent adhesive layer 11 onto the light exiting surface of the light guide plate 2;

adhesively fixing (for example, pressing and adhering) the diffusion sheet 3 onto the light exiting surface of the light guide plate 2 by the first transparent adhesive layer 11;

providing (for example, uniformly transferring) the second transparent adhesive layer 12 onto the diffusion sheet 3 and adhesively fixing (for example, pressing and adhering) the prism sheet 4 onto the diffusion sheet 3 by the second transparent adhesive layer 12;

providing (for example, uniformly transferring) the second transparent adhesive layer 12 onto the prism sheet 4 and adhesively fixing (for example, pressing and adhering) the first protective sheet 7 onto the prism sheet 4 by the second transparent adhesive layer 12.

In this way, an integral optical assembly as shown in FIG. 2 is formed herein.

FIG. 3 is a schematic sectional view of an optical assembly for a backlight module in accordance with a second embodiment of the present invention. As compared with the optical assembly shown in FIG. 2, the optical assembly shown in FIG. 3 has the following differences: the use of a holographic light guide plate 21 having a light diffusing function, so as to remove the diffusion sheet. In addition, the same components are remarked by the same reference numbers, and therefore the detailed explanation on the same components is omitted herein.

The light exiting surface of the holographic light guide plate 21 is adhesively fixed with the prism sheet 4 by the first transparent adhesive layer 11, while the prism sheet 4 is adhesively fixed with the first protective sheet 7 by the second transparent adhesive layer 12. Another side of the holographic light guide plate 21 opposite to the light exiting surface is a network node surface provided with network nodes. This network node surface is provided with the reflecting layer 6.

In other words, the set of optical membranes in the present embodiment only includes the prism sheet 4 and the first protective sheet 7. providing the light guide plate as the holographic light guide plate 21 having the light diffusion function (which not only has the common function of the light guide plate, but also has the light diffusion function on the light exiting surface thereof), can dispense with the diffusion sheet necessary for the backlight module in the prior art, and reduce the thickness of the integral optical assembly, thereby further decreasing the thickness of the backlight module.

The optical assembly as shown in FIG. 3 can be obtained by the following steps:

peeling off a protective film on the reflecting surface of the holographic light guide plate 21, and forming a network node surface by making network nodes on the reflecting surface of the holographic light guide plate 21;

coating the reflecting layer 6 onto the network node surface, and disposing (for example, adhering) the second protective sheet 8 onto the reflecting layer 6 by the first or second transparent adhesive layer 11 or 12;

peeling off a protective film on the light exiting surface of the holographic light guide plate 21 and providing (for example, uniformly transferring) the first transparent adhesive layer 11 onto the light exiting surface of the holographic light guide plate 21;

adhesively fixing (for example, pressing and adhering) the prism sheet 4 onto the light exiting surface by the first transparent adhesive layer 11;

providing (for example, uniformly transferring) the second transparent adhesive layer 12 onto the prism sheet 4 and adhesively fixing (for example, pressing and adhering) the first protective sheet 7 onto the prism sheet 4 by the second transparent adhesive layer 12.

In this way, an integral optical assembly as shown in FIG. 3 is formed herein.

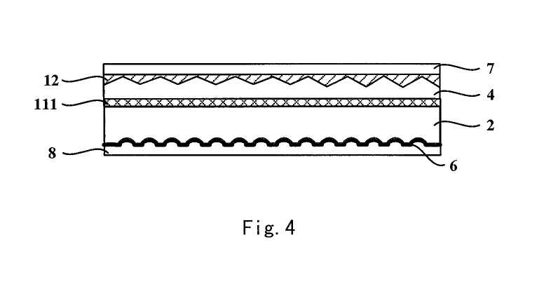

FIG. 4 is a schematic sectional view of an optical assembly for a backlight module in accordance with a third embodiment of the present invention. As compared with the optical assembly shown in FIG. 2, the optical assembly shown in FIG. 4 has the following differences: the use of a light diffusion transparent adhesive layer 111 having light diffusion particles so as to remove the diffusion sheet. In addition, the same components are remarked by the same reference numbers, and therefore the detailed explanation on the same components is omitted herein.

The light exiting surface of the light guide plate 2 is adhesively fixed with the prism sheet 4 by the light diffusion transparent adhesive layer 111, while the prism sheet 4 is adhesively fixed with the first protective sheet 7 by the second transparent adhesive layer 12. The reflecting surface of the light guide plate 2 is a network node surface provided with network nodes. This network node surface is provided with the reflecting layer 6.

In other words, similar to that shown in FIG. 3, the set of optical membranes in the present embodiment only includes the prism sheet 4 and the first protective sheet 7. However, it is not rather to dispose the light guide plate to be a component having the light diffusion function, but to dispose the first transparent adhesive layer as shown in FIG. 2 to be a connecting member having the light diffusion function. In this way, it also can dispense with the diffusion sheet necessary for the backlight module in the prior art, and reduce the thickness of the integral optical assembly, thereby further decreasing the thickness of the backlight module. The light diffusion transparent adhesive layer 111 can be obtained by doping the particles having the light diffusion function into the first transparent adhesive layer as shown in FIG. 2. The sizes and doping concentrations of the diffusion particles can be set according to those of the diffusion particles in the existing diffusion sheet. In other words, the light diffusion transparent adhesive layer 111 can have a light transmissivity higher than 90%.

The optical assembly as shown in FIG. 4 can be obtained by the following steps:

peeling off a protective film on the reflecting surface of the light guide plate 2, and forming a network node surface by making network nodes on the reflecting surface of the light guide plate 2;

coating the reflecting layer 6 onto the network node surface, and disposing (for example, adhering) the second protective sheet 8 onto the reflecting layer 6 by the first or second transparent adhesive layer 11 or 12;

peeling off a protective film on the light exiting surface of the light guide plate 2 and providing (for example, uniformly transferring) the light diffusion transparent adhesive layer 111 onto the light exiting surface of the light guide plate 2;

adhesively fixing (for example, pressing and adhering) the prism sheet 4 onto the light exiting surface of the light guide plate 2 by the light diffusion transparent adhesive layer 111;

providing (for example, uniformly transferring) a transparent adhesive layer similar to the second transparent adhesive layer 12 onto the prism sheet 4 and adhesively fixing (for example, pressing and adhering) the first protective sheet 7 onto the prism sheet 4 by the second transparent adhesive layer 12.

In this way, an integral optical assembly as shown in FIG. 4 is formed herein.

In other embodiments of the present invention, it further provides a backlight module, comprising:

the optical assembly as describe in any one of the above described embodiments;

a backlight source located at a light incidence side of the light guide plate; and

a support plate for securing the optical assembly and the backlight source.

In this backlight module, since the optical assembly is of an integral member, it significantly reduces the poor yield issues of the assembly. In addition, it can also dispense with the existing glue frame or glue tape for securing the respective optical parts in the backlight module, thereby largely reducing the difficulty of the assembling backlight module.

Other embodiments of the present invention also provide a display device, including the above described backlight module, and a display panel located at the light exiting side of the backlight module.

Since the above described backlight module has produced the technical effects as set out above, the assembling of the backlight module of the display device is very simple, and this improves the producing efficiency of the display device. In addition, in the case of using the optical assembly in accordance with the second or third embodiment of the present invention, the thickness of the backlight module is significantly reduced, and thus the thickness of the display device is reduced accordingly.

Although several exemplary embodiments have been shown and described, the present invention is not limited to those and it would be appreciated by those skilled in the art that various changes or modifications may be made in these embodiments without departing from the principles and spirit of the disclosure. These changes or modifications also fall within the scope of the present invention. The scope of the present invention is defined by the claims and their equivalents.

What is claimed is:

1. An optical assembly for a backlight module, comprising:
a light guide plate; and
a set of optical membranes located on a light exiting surface of the light guide plate;
wherein the light guide plate is adhesively fixed with the set of optical membranes by a first transparent adhesive layer.

2. The optical assembly according to claim 1, wherein respective optical membranes of the set of optical membranes are adhesively fixed with each other by a second transparent adhesive layer.

3. The optical assembly according to claim 2, wherein the set of optical membranes comprises a diffusion sheet, a prism sheet and a first protective sheet sequentially disposed onto the light exiting surface of the light guide plate.

4. The optical assembly according to claim 2, wherein the light guide plate is a holographic light guide plate; and the set of optical membranes comprises a prism sheet and a first protective sheet sequentially disposed onto the light exiting surface of the light guide plate.

5. The optical assembly according to claim 2, wherein the first transparent adhesive layer is a light diffusion transparent adhesive layer; and the set of optical membranes comprises a prism sheet and a first protective sheet sequentially disposed onto the light exiting surface of the light guide plate.

6. The optical assembly according to claim 2, wherein the first transparent adhesive layer has a light transmissivity higher than 90%, and is made of any one of organic silicon rubber, acrylic resin, unsaturated polyester resin, polyurethane resin and epoxy resin or any combination thereof; and/or
the second transparent adhesive layer has a light transmissivity higher than 90%, and is made of any one of organic silicon rubber, acrylic resin, unsaturated polyester resin, polyurethane resin and epoxy resin or any combination thereof.

7. The optical assembly according to claim 5, wherein the light diffusion transparent adhesive layer has a light transmissivity higher than 90%, and is made of any one of organic silicon rubber, acrylic resin, unsaturated polyester resin, polyurethane resin and epoxy resin or any combination thereof, with being doped by light diffusion particles.

8. The optical assembly according to claim 1, wherein a side of the light guide plate opposite to the light exiting surface is a network node surface provided with network nodes, and the network node surface is provided with a reflecting layer thereon.

9. The optical assembly according to claim 8, wherein the optical assembly further comprises a second protective sheet located on a side of the reflecting layer facing away from the light guide plate, and the second protective sheet is adhesively fixed with the reflecting layer by the first transparent adhesive layer.

10. The optical assembly according to claim 2, wherein a side of the light guide plate opposite to the light exiting surface is a network node surface provided with network nodes, and the network node surface is provided with a reflecting layer.

11. The optical assembly according to claim 10, wherein the optical assembly further comprises a second protective sheet located on a side of the reflecting layer facing away from the light guide plate, and the second protective sheet is adhesively fixed with the reflecting layer by the second transparent adhesive layer.

12. A manufacturing method for an optical assembly, comprising the following steps:
forming a network node surface by making network nodes on a reflecting surface of the light guide plate;
coating a reflecting layer onto the network node surface and adhesively fixing a second protective sheet onto the reflecting layer by a transparent adhesive layer;
adhesively fixing a set of optical membranes onto a light exiting surface of the light guide plate by a first transparent adhesive layer; and
adhesively fixing respective optical membranes of the set of optical membranes by a second transparent adhesive layer.

13. The manufacturing method according to claim 12, wherein
the step of adhesively fixing a set of optical membranes onto a light exiting surface of the light guide plate by a first transparent adhesive layer comprises:
adhesively fixing a diffusion sheet of the set of optical membranes onto the light exiting surface by the first transparent adhesive layer;
the step of adhesively fixing respective optical membranes of the set of optical membranes by a second transparent adhesive layer comprises:
adhesively fixing a prism sheet onto the diffusion sheet by the second transparent adhesive layer; and
adhesively fixing a first protective sheet onto the prism sheet by the second transparent adhesive layer.

14. The manufacturing method according to claim 12, wherein the light guide plate is a holographic light guide plate,
the step of adhesively fixing a set of optical membranes onto a light exiting surface of the light guide plate by a first transparent adhesive layer comprises:
adhesively fixing a prism sheet of the set of optical membranes onto the light exiting surface of the holographic light guide plate by the first transparent adhesive layer;
the step of adhesively fixing respective optical membranes of the set of optical membranes by a second transparent adhesive layer comprises:
adhesively fixing a first protective sheet onto the prism sheet by the second transparent adhesive layer.

15. The manufacturing method according to claim 12, wherein the first transparent adhesive layer is a light diffusion transparent adhesive layer,
the step of adhesively fixing a set of optical membranes onto a light exiting surface of the light guide plate by a first transparent adhesive layer comprises:
adhesively fixing a prism sheet of the set of optical membranes onto the light exiting surface of the light guide plate by the light diffusion transparent adhesive layer;
the step of adhesively fixing respective optical membranes of the set of optical membranes by a second transparent adhesive layer comprises:
adhesively fixing a first protective sheet onto the prism sheet by the second transparent adhesive layer.

16. A display device, comprising:
a backlight module, comprising:
the optical assembly according to claim 1,
a backlight source located at a light incidence side of the light guide plate, and
a support plate for securing the optical assembly and the backlight source; and
a display panel located at a light exiting side of the backlight module.

17. The display device according to claim 16, wherein respective optical membranes of the set of optical membranes are adhesively fixed with each other by a second transparent adhesive layer.

18. The display device according to claim 17, wherein the set of optical membranes comprises a diffusion sheet, a prism sheet and a first protective sheet sequentially disposed onto the light exiting surface of the light guide plate.

19. The display device according to claim 17, wherein the light guide plate is a holographic light guide plate; and the set of optical membranes comprises a prism sheet and a first protective sheet sequentially disposed onto the light exiting surface of the light guide plate.

20. The display device according to claim 17, wherein the first transparent adhesive layer is a light diffusion transparent adhesive layer; and the set of optical membranes comprises a prism sheet and a first protective sheet sequentially disposed onto the light exiting surface of the light guide plate.
